(19) United States
(12) Patent Application Publication
(10) Pub. No.: US 2008/0230487 A1
(43) Pub. Date: Sep. 25, 2008

(54) Chemical process

(75) Inventor: Saurabh Malhotra, New Delhi (IN)

Correspondence Address: FROMMER LAWRENCE & HAUG, 745 FIFTH AVENUE- 10TH FL., NEW YORK, NY, 10151, US

(73) Assignee: Malhotra Oil Company

(21) Appl. No.: 11/725,813

(22) Filed: Mar. 20, 2007

(51) Int. Cl. B01D 17/00

(52) U.S. Cl. 210/766

(57) ABSTRACT

A novel chemical process has been developed for the first time for the disposal of greases and manufacture of industrial fuels therefrom. Details of the method for disposing by the new chemical approach have been described. The “degrading agent” used in this method ruptures soap matrices and helps the separation of soap and base oil. The solution derived from the research work is waste-to-energy process and can be used as cost effective fuel for industrial purpose.

### FIELD OF INVENTION

This present invention relates to a method for the disposal of greases and manufacture of industrial fuels therefrom and it is a new chemical approach particularly to dispose greases. In this method, during the separation of base oil from soap, a degrading agent is added which results into the rupture of soap matrices, thereby facilitates the separation of base oil from soap. The primary role of degrading agent in this invention is to speed up the separation process by weakening molecular forces within soap matrices resulting easy removal of base oil from thickener. The uniqueness of the present invention is to convert waste grease into a useful industrial fuel thru more environment friendly and economically viable ways & means.

### BACKGROUND OF INVENTION

Lubricating greases are being used in various industries namely, Automotive, Steel, Power, Mining, cement, Agro machineries, Chemical etc. Total worldwide volume of lubricating grease is over 7, 63,000 MTPA, where India & Indian sub continents constitute around 10-12% of total volume. (The grease composition employs an oil of lubricating viscosity, particularly including natural oils. Natural oils include animal oils, vegetable oils, mineral oils, solvent or acid treated mineral oils, and oils derived from coal or shale.

As more than 90% lubricating oils & greases are mineral oil based, which are non-biodegradable and therefore these are not environment friendly. Hence, it is becoming growing concern to dispose oils & greases more efficiently as well as safely. Although quite few methods and practices are adapted to dispose only used lubricating oils, however there is no viable method, which disposes lubricants both economically and environmentally. Currently, there are two major approaches are being followed worldwide to dispose used oil, namely
Reclamation
Recycling

Reclamation in general involves cleaning, drying and perhaps adsorption to remove color, acids & sludge. The reclaiming of lube oil is essentially a non-chemical process that restores in service lubricating oil for reuse in a system. Recycling: Reuse of waste oil can include burning with out treatment (not advised), reprocessing to industrial fuel, re-refining to new lube oil and disposal to landfill (to be avoided). In some countries used oil collection schemes are in place and used oil is recycled, however it is still the case that most used oil is burned as industrial fuel like in cement mills, lime kilns, coke ovens, and blast furnaces. Re-refining is another disposal route, which requires capital investment, but only small fraction of used oil is currently recycled mainly because quality of refined oil is inconsistent and often leads to poor performance characteristics for finished lubricants blended from them.

One of the alternate approaches in the industry is going for long drain interval oils and using greases having longer life and even fill-for-life concept is emerging in the market. This approach definitely reduces the amount of pressure to dispose lubricant however the issue of disposal of lubricant via most acceptable method remains unresolved. When the scrap greases are either incinerated or buried in the pit one should not ignore the likely damages it may have to the environment. Though in India, environment laws are not strict as in United States and European countries, however in view of user industries are forced to follow only eco-friendly disposal method but the fact is that as on date there is no foolproof method available for the disposal of greases. In comparison to lubricating oil, in the past, worldwide not much importance was given to grease; however there is a growing environmental consciousness nowadays and there is need & some time enforcement by various agencies to adopt suitable disposal methods for greases as the various current practices adopted by industry like burning of greases, disposal to landfill etc are not acceptable by the environmentalists.

Currently, the market for used grease has stymied many recycling and reclamation efforts. Only a limited amount of used grease is reclaimed and converted into a recycled oil product. Used grease retains a high energy potential however, hazards and cost associated with collecting, storing, transporting, and general handling of used grease has limited the efforts to collect used grease for disposal or recycling. There is a need for improvement within the art of converting used grease to a high quality energy source. Therefore, used greases as well as off specification greases have now become a grave concern for disposal.

### OBJECT OF THE INVENTION

The primary object of this invention is to propose a novel method for the disposal of lubricating greases and manufacture of industrial fuels therefrom.

Another object of this invention is to propose a more viable chemical method to dispose bio and non-biodegradable greases.

Further object of this invention is to use commercially viable diluents/gas oil to facilitate the separation of mineral oil & soap.

Yet another object of this invention is to propose a novel method to dispose the waste greases and off specification greases at commercial level by way of using cost effective diluents/gas oil in an equipment having relatively simple design.

Yet another object of this invention is directed towards the art of converting grease to a useable fuel source.

Yet another object of this invention is to propose chemical process to ease efficiently extract mineral oil from grease and convert them into a useful energy.

Further objects and advantages of the invention become more apparent in light of the following detailed description of the preferred embodiments of the invention.

### SUMMARY OF THE INVENTION

The present invention provides a convenient chemical method for disposing of greases by using suitable degrading agent at an optimized process conditions followed by effective separation of soap & mineral oil from used grease. In other words, by this novel method a thick solution of grease in diluents is treated with strong alkali at moderate temperature (60-80° C.). The soap separated from mineral oil in grease is allowed to sediment at the bottom. The soap considered as biodegradable, is disposed as such where as mineral oil containing sizeable amount of diluents could be used as an industrial fuel similar to the existing practices as burning waste oil to produce energy is an inexpensive solution and it does not damage the environment.

### DETAILED DESCRIPTION OF THE INVENTION

Greases are typically prepared by thickening an oil base stock. The greases taken for this invention are oil-based, that is, they comprise oil, which has been thickened with a thickener, also referred to as a thickening agent. Greases are generally distinguished from oils in that they exhibit a yield point (at room temperature or at the temperature of use) while oils do not. That is, below a certain level of applied stress, greases will generally not flow; whereas oils will flow under an arbitrarily small stress, if very slowly. In practice this often means that greases cannot be poured and appear to be a solid or semisolid, while oils can be poured and have the characteristics of a fluid, even if a very viscous fluid. Compositionally, greases are often heterogeneous compositions, comprising a suspension of one material, often a fibrous crystalline material in another. On the other hand, oils are normally more uniform, at least on a macroscopic scale, often comprising an apparently homogeneous solution of materials. Oils often exhibit Newtonian flow behavior; greases do not. In greases, oil is held in grease structure (fibrous material) by molecular and capillary forces. These simple physical phenomenons emphasize the fact that unlike oil, grease is more complex in nature and therefore difficult to separate by conventional methods.

In traditional grease formulation, thickeners are incorporated into a base oil, typically, an oil of lubricating viscosity in amounts typically from 1 to 30% by weight, more often from 1 to 15% by weight, of the base grease composition. The specific amount of thickener required often depends on the thickener employed. The type and amount of thickener employed is frequently dictated by the desired nature of the grease. The type and amount are also dictated by the desired consistency, which is a measure of the degree to which the grease resists deformation under application of force. Consistency is usually indicated by the ASTM Cone penetration test, ASTM D-217 or ASTM D-1403. Types and amounts of thickeners to employ are well known to those skilled in the grease art and are further described in the NLGI Lubricating Grease Guide.

To achieve the said objects, the present invention provides a viable chemical process for disposing lubricating grease. The scale of experiment varies from 0.5 Kg to 6.0 Kg. In the first phase, the experiments were done in laboratory scale, say 0.5 to 2 Kg and later in the second phase, experiments on selected compositions were done in the pilot scale, say 4 to 6 Kg. The chemical process comprises of the following steps.
i. Taking known quantity of grease & diluents in a appropriate container equipped with heating and strong agitating device
ii. Heating the diluted grease to about 40-90° C.
iii. Adding slowly required quantity of degrading agent with mixing
iv. Holding the temperature of the mixture at 60-80° C. for about 2-3 hrs with continuous agitation
v. Cool the mixture to ambient temperature and leave it undisturbed for about 5-8 hrs.

The mixture is heated in step (i) up to 70-80° C. The amount of diluents used in this process is 3 times more than the total quantity of used grease taken for disposal. The amount of degrading agent (10-20% aqueous alkali solution) used in this process is equal to the quantity of used grease. The process temperature and concentration of degrading agent may vary slightly with the respect to the amount of thickener present in the grease. It can be observed that proper agitation facilitates the mixing of diluents in grease and helps in reducing process temperature. It is found that the presence of bituminous material/fillers in the grease hinders the separation of soap from base oil. The diluents are mineral spirit, ethyl acetate, acetonitrile, toluene, kerosene, diesel or light diesel oil or combinations thereof. The degrading agent is either aqueous solution of alkali carbonates, bicarbonates & hydroxides or glacial acetic acid or perchloric acid. The soap deposited at the bottom is separated from diluents can be disposed as such after diluting with water where as the diluents, containing the mineral oil. The mineral oil so obtained can be used as an industrial fuel as all the greases generally contains mineral oils/synthetic oils as base oil in the consideration of 70-90%.

The following examples are given as non-limitative illustrations of aspects of the present invention.

### EXAMPLE 1

To a 5 L steel container equipped with agitating (high torque stirrer) and heating devices, is charged with 0.5 Kg of Li soap based grease. To the container is added 2.5 L of hexane or petroleum ether (40-60° C. fraction). The mixture is added 0.5 L of 10% aqueous NaOH solution. The mixture is heated slowly to 50-60° C. for 2-3 hrs with continuous agitation. Thereafter the mixture is allowed to cool and left undisturbed for at least 3 hrs. A clear separation of oil layer (top) and aqueous alkali layer (bottom) is obtained. Analysis of top portion reveals that base oil & soluble additives are present in major amount and it has the characteristics of furnace oil/Light Diesel oil (Table-1). Bottom layer contains soap, water & alkali, which may be washed once with aliquot amount of hexane to remove residual oil, dried and diluted further with water to make it readily disposable.

TABLE 1
Comparative test data of organic layer (top portion)

| S. | | Test | Furnace | Light | Organic |
|---|---|---|---|---|---|
| No | Property | Method | oil | diesel oil | layer |
| 1 | Acidity, inorganic | P:2 | NIL | NIL | NIL |
| | mg, KOH/gm | | | | |
| 2 | Ash, % wt | P:4 | 0.1 | 0.02 | 0.02 |
| 3 | Flash Point, C. | P:21 | 66 | 66 | 63 |
| | (PMCC) | | | | |
| 4 | KV at 50 deg C., | P:25 | 80/125/180/ | 2.5–15.7 | 30–40 |
| | cSt | | 370 | | |
| 5 | Sediments, % wt | P:30 | 0.25 | 0.10 | NIL |
| 6 | Sulphur, total % wt | XRF | 8.5–14.5 | 1.8 | — |
| 7 | Water, % vol, max | P:40 | 1.0 | 0.25 | 0.20 |

### EXAMPLE 2

Example 1 is substantially repeated except that Li complex soap based grease is used in place of Li soap grease and aqueous KOH solution in place of NaOH solution. Up on cooling the final mixture, a distinct oil layer (top) and aqueous alkali layer (bottom) is obtained. Analysis of organic layer (top portion) is found to have physico-chemical characteristics similar to that of furnace oil/light diesel oil as given in Table-2.

TABLE 2
Comparative test data of organic layer (top portion)

| S. | | Test | Furnace | Light | Organic |
|---|---|---|---|---|---|
| No | Property | Method | oil | diesel oil | layer |
| 1 | Acidity, inorganic | P:2 | NIL | NIL | NIL |
| | mg, KOH/gm | | | | |
| 2 | Ash, % wt | P:4 | 0.1 | 0.02 | 0.05 |
| 3 | Flash Point, C. | P:21 | 66 | 66 | 65 |
| | (PMCC) | | | | |
| 4 | KV at 50 deg C., | P:25 | 80/125/180/ | 2.5–15.7 | 30–40 |
| | cSt | | 370 | | |
| 5 | Sediments, % wt | P:30 | 0.25 | 0.10 | NIL |
| 6 | Sulphur, total % wt | XRF | 8.5–14.5 | 1.8 | — |
| 7 | Water, % vol, max | P:40 | 1.0 | 0.25 | 0.30 |

### EXAMPLE 3

To a 5 L steel container equipped with agitating and heating devices, is charged with 0.5 Kg of Li soap based grease. To the container is added 2.5 L of hexane or petroleum ether (40-60° C. fraction). The mixture is added 100 g of glacial acetic acid. The mixture is heated slowly to 60-70° C. for 3-5 hrs with continuous agitation. Thereafter the mixture is allowed to cool and left undisturbed for at least 5 hrs. The mixture separated to give oil layer at the top and slurry at the bottom. There is no complete separation as significant amount of oil & diluent found to present in the slurry.

### EXAMPLE 4

To a 5 L steel container equipped with agitating and heating devices, is charged with 0.5 Kg of Li soap based grease. To the container is added 2.5 L of mixture of hexane & kerosene (1:4 ratio). The mixture is added 0.5 L of 10% aqueous NaOH solution. The mixture is heated slowly to 60-70° C. for 3-5 hrs with continuous agitation. Thereafter the mixture is allowed to cool and left undisturbed for at least 8 hrs. A clear separation of oil layer (top) and aqueous alkali layer (bottom) is obtained, which then processed as described in Example 1.

### EXAMPLE 5

To a 15 Kg grease kettle equipped with strong agitating & heating devices is charged with 2 Kg of grease (either Li or Li complex soap based). To the kettle is added 6 Kg of Diesel. The mixture is agitated vigorously for an hour. To the mixture is added 2 Kg of 20% aqueous NaOH solution and thereafter the mixture is heated slowly to 60-70° C. for 3-5 hrs with continuous agitation. After cooling down the mixture to ambient temperature, it is kept undisturbed for at least 5 hrs. A clear separation of oil layer (top) and aqueous alkali layer (bottom) is obtained. Analysis of top portion reveals that base oil & soluble additives are present in major amount and it has the characteristics of furnace oil/Light Diesel oil (Table-3). Bottom layer contains soap, water & alkali, which may be washed once with aliquot amount of mineral spirit to remove residual oil, dried and diluted further with water to make it readily disposable.

TABLE 3
Comparative test data of organic layer (top portion)

| S. | | Test | Furnace | Light | Organic |
|---|---|---|---|---|---|
| No | Property | Method | oil | diesel oil | layer |
| 1 | Acidity, inorganic | P:2 | NIL | NIL | NIL |
| | mg, KOH/gm | | | | |
| 2 | Ash, % wt | P:4 | 0.1 | 0.02 | 0.06 |
| 3 | Flash Point, C. | P:21 | 66 | 66 | 70 |
| | (PMCC) | | | | |
| 4 | KV at 50 deg C., | P:25 | 80/125/180/ | 2.5–15.7 | 30–40 |
| | cSt | | 370 | | |
| 5 | Sediments, % wt | P:30 | 0.25 | 0.10 | 0.07 |
| 6 | Sulphur, total % wt | XRF | 8.5–14.5 | 1.8 | — |
| 7 | Water, % vol, max | P:40 | 1.0 | 0.25 | 0.30 |

### EXAMPLE 6

To a 15 Kg kettle is charged with 2 Kg of grease (Li or Li complex soap). To the kettle is added 6 Kg of Light Diesel Oil and the mixture is agitated vigorously for an hour. To the mixture is added 2 Kg of 20% aqueous NaOH solution and thereafter the mixture is heated slowly to 50-60° C. for 3 hrs with continuous agitation. After cooling the mixture to ambient temperature, it is left undisturbed for about 8 hrs. A clear separation of oil layer (top) and aqueous alkali layer (bottom) is obtained. As described in Example 5 both top and bottom portions are collected separately and analyzed. Top portion may be washed once with water to remove residual alkali/alkali salt and then the mixture may be treated as a source for energy. The bottom portion which is biodegradable may be disposed as such after diluting with copious amount of water.

### EXAMPLE 7

To a 15 Kg kettle is charged with 2 Kg of Li—Ca mixed soap based grease. To the kettle is added 6 Kg of Diesel and the mixture is agitated vigorously for 1-2 hrs. To the mixture is added 2 Kg of 20% aqueous NaOH solution and thereafter the mixture is heated slowly to 70-80° C. for 5 hrs with continuous agitation. After cooling the mixture to ambient temperature, it is left undisturbed for about 8 hrs. A clear separation of oil layer (top) and aqueous alkali layer (bottom) is obtained. Analysis of top portion reveals that base oil & soluble additives are present in major amount and it has the characteristics of furnace oil/Light Diesel oil (Table-4). Bottom layer contains soap, water & alkali, which may be washed once with aliquot amount of mineral spirit to remove residual oil, dried and diluted further with water to make it readily disposable.

TABLE 4
Comparative test data of organic layer (top portion)

| S. | | Test | Furnace | Light | Organic |
|---|---|---|---|---|---|
| No | Property | Method | oil | diesel oil | layer |
| 1 | Acidity, inorganic | P:2 | NIL | NIL | NIL |
| | mg, KOH/gm | | | | |
| 2 | Ash, % wt | P:4 | 0.1 | 0.02 | 0.05 |
| 3 | Flash Point, C. | P:21 | 66 | 66 | 66 |
| | (PMCC) | | | | |
| 4 | KV at 50 deg C., | P:25 | 80/125/180/ | 2.5–15.7 | 40 |
| | cSt | | 370 | | |
| 5 | Sediments, % wt | P:30 | 0.25 | 0.10 | 0.10 |
| 6 | Sulphur, total % wt | XRF | 8.5–14.5 | 1.8 | — |
| 7 | Water, % vol, max | P:40 | 1.0 | 0.25 | 0.35 |

### EXAMPLE 8

In the examples 1-7 mentioned above, the distinct oil layer (top portion) obtained upon cooling the final mixture can be distilled to get the respective diluent, which can be used further and the distillate (used oil) thus collected may possibly either dispose by following the existing practices for the disposal of used lubricating oils or by reclamation/recycling technique. The bottom portion that contains soap, water & alkali, may be washed once with aliquot amount of mineral spirit to remove any residual oil, dried and since it is in strong alkaline medium, it may be diluted further with profuse amount of water to make it readily disposable.

We claim:

1. A process for disposal of lubricating greases and manufacture of industrial fuels therefrom comprises following steps:—
a) taking known quantity of grease and diluents in an appropriate container equipped with heating and a strong agitating or mixing device to form diluted grease,
b) heating the said diluted grease to about 40-90° C.,
c) adding slowly required quantity of degrading agent with mixing, and maintaining the temperature of the mixture at 60-80° C. for about 2-3 hours with continuous agitation or mixing,
d) cooling the mixture to ambient temperature, and keeping it undisturbed for 5-8 hours which results in separation of top organic layer and bottom aqueous layer,
e) collecting the two distinct portions (organic and aqueous) separately,
f) subjecting the top organic portion collected separately to washing with water to remove any remaining water soluble components,
g) subjecting the organic portion so obtained after washing with water is to distillation to recover the diluents which may be used further,
h) the organic portion so obtained can be used as an industrial fuel

2. A process as claimed in claim 1 wherein said diluents are selected from mineral spirit, ethyl acetate, acetonitrile, toluene, kerosene, low speed diesel or light diesel oil or combinations thereof.

3. A process as claimed in claim 1 wherein the said grease is either Li, Ca, Li—Ca mixed or Li-Complex soap based.

4. A process as claimed in claim 1 wherein the said degrading agent is either aqueous solution of alkali carbonate, bicarbonates and hydroxides or acetic acid or perchloric acid.

5. A process as claimed in claim 1 wherein grease, diluents and degrading agents are taken in the ratio of 1:5:1 respectively.
